(19) United States
(12) Patent Application Publication
(10) Pub. No.: US 2019/0364558 A1
(43) Pub. Date: Nov. 28, 2019

(54) PHYSICAL UPLINK CONTROL CHANNEL TRANSMISSION/RECEPTION METHOD BETWEEN TERMINAL AND BASE STATION IN WIRELESS COMMUNICATION SYSTEM AND DEVICE SUPPORTING SAME

(71) Applicant: LG ELECTRONICS INC., Seoul (KR)

(72) Inventors: Seonwook KIM, Seoul (KR); Suckchel YANG, Seoul (KR); Hanjun PARK, Seoul (KR); Joonkui AHN, Seoul (KR)

(73) Assignee: LG ELECTRONICS INC., Seoul (KR)

(21) Appl. No.: 16/347,529

(22) PCT Filed: Nov. 6, 2017
(86) PCT No.: PCT/KR2017/012457

§ 371 Date: May 3, 2019

Related U.S. Application Data
(60) Provisional application No. 62/417,420, filed on Nov. 4, 2016.
(60) Provisional application No. 62/454,073, filed on Feb. 3, 2017.
(60) Provisional application No. 62/454,956, filed on Feb. 6, 2017.
(60) Provisional application No. 62/559,615, filed on Sep. 17, 2017.

(51) Int. Cl. H04W 72/04

(52) U.S. Cl. CPC H04W 72/0413; H04L 5/0007; H04W 72/0446; H04W 72/0453

(57) ABSTRACT

The present invention provides a physical uplink control channel transmission/reception method between a user equipment and a base station in a wireless communication system and a device supporting the same. Proposed is a physical uplink control channel transmission method wherein a user equipment determines a PUCCH transmission subband for PUCCH transmission according to whether an uplink control subband (UL control subband) is configured, and performs PUCCH transmission using a PUCCH resource in the determined PUCCH transmission subband in a wireless communication system.

### TECHNICAL FIELD

The following description relates to a wireless communication system, and more particularly, to a method for transmitting and receiving a physical uplink control channel between a user equipment and a base station, and a device supporting the same.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

As described above, the introduction of the next generation RAT considering the enhanced mobile broadband communication, massive MTC, Ultra-reliable and low latency communication (URLLC), and the like has been discussed.

### DISCLOSURE

### Technical Problem

An object of the present invention is to provide a method for transmitting and receiving a physical uplink control channel between a user equipment and a base station in a newly proposed communication system.

In particular, an object of the present invention is to provide a method for transmitting and receiving a physical uplink control channel through an uplink control subband determined according to whether an uplink control subband in which a physical uplink control channel is transmitted and received is configured by a base station in a newly proposed communication system.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

The present invention provides a method and apparatuses for transmitting and receiving a physical uplink control channel between a user equipment and a base station in a wireless communication system.

In one aspect of the present invention, provided herein is a method for transmitting a physical uplink control channel (PUCCH) by a user equipment to a base station in a wireless communication system, the method including determining a PUCCH transmission subband for transmitting a PUCCH based on whether a uplink (UL) control subband is configured, and transmitting the PUCCH using a PUCCH resource in the determined PUCCH transmission subband.

In another aspect of the present invention, provided herein is a method for receiving a physical uplink control channel (PUCCH) by a base station from a user equipment in a wireless communication system, the method including receiving the PUCCH using a PUCCH resource in a PUCCH transmission subband determined based on whether a UL control subband is configured by the base station.

In another aspect of the present invention, provided herein is a user equipment for transmitting a physical uplink control channel to a base station in a wireless communication system, the user equipment including a transmitter, and a processor operatively coupled with the transmitter, wherein the processor is configured to determine a PUCCH transmission subband for transmitting a PUCCH based on whether a uplink (UL) control subband is configured, and to transmit the PUCCH using a PUCCH resource in the determined PUCCH transmission subband.

In another aspect of the present invention, provided herein is a base station for receiving a physical uplink control channel from a user equipment in a wireless communication system, the base station including a receiver, and a processor operatively coupled with the receiver, wherein the processor is configured to receive the PUCCH using a PUCCH resource in a PUCCH transmission subband determined based on whether a UL control subband is configured by the base station.

Herein, when the user equipment receives signaling for configuring a UL control subband from the base station, the PUCCH transmission subband may be determined as a subband indicated by the received signaling. In this case, the PUCCH transmission subband may be configured independently from a subband for uplink data transmission.

Herein, a bandwidth of the PUCCH transmission subband may be configured to be smaller than a bandwidth of the subband for the uplink data transmission.

Alternatively, when the user equipment does not receive signaling for configuring a UL control subband from the base station, the PUCCH transmission subband may be configured to be identical to a subband for uplink data transmission.

Herein a PUCCH resource, included in the PUCCH transmission subband, on which the PUCCH is transmitted may be determined based on an index of a resource, included in a specific downlink control subband, on which a physical downlink control channel (PDCCH) corresponding to the PUCCH is transmitted.

In addition, the subband in which the PUCCH is transmitted may have a smaller bandwidth than one component carrier supported by the wireless communication system.

Herein, the one component carrier may have a bandwidth of up to 400 MHz.

When the user equipment is to additionally transmit a physical uplink shared channel (PUSCH), the UE may transmit the PUSCH by performing rate-matching or puncturing on the PUCCH resource on which the PUCCH is transmitted.

It is to be understood that both the foregoing general description and the following detailed description of the present disclosure are exemplary and explanatory and are intended to provide further explanation of the disclosure as claimed.

### Advantageous Effects

As is apparent from the above description, the embodiments of the present invention have the following effects.

According to the present invention, a user equipment may transmit a PUCCH through a PUCCH transmission subband determined according to whether an uplink control subband is configured by a base station.

As described above, the base station may dynamically configure the PUCCH transmission subband in consideration of the capability of the user equipment, multiplexing with other user equipments, system load balancing, and the like. Thereby, the wireless communication system according to the present invention may support multiplexing of PUCCH channels and/or dynamic load balancing.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings. In other words, unintended effects according to implementation of the present invention may also be obtained by those skilled in the art from the embodiments of the present invention.

### DESCRIPTION OF DRAWINGS

The accompanying drawings, which are included to provide a further understanding of the invention, provide embodiments of the present invention together with detail explanation. Yet, a technical characteristic of the present invention is not limited to a specific drawing. Characteristics disclosed in each of the drawings are combined with each other to configure a new embodiment. Reference numerals in each drawing correspond to structural elements.

FIG. 1 is a diagram illustrating physical channels and a signal transmission method using the physical channels;

FIG. 2 is a diagram illustrating exemplary radio frame structures;

FIG. 3 is a diagram illustrating an exemplary resource grid for the duration of a downlink slot;

FIG. 4 is a diagram illustrating an exemplary structure of an uplink subframe;

FIG. 5 is a diagram illustrating an exemplary structure of a downlink subframe;

FIG. 6 is a diagram illustrating a self-contained subframe structure applicable to the present invention;

FIGS. 7 and 8 are diagrams illustrating representative methods for connecting TXRUs to antenna elements;

FIG. 9 is a diagram schematically illustrating an exemplary hybrid beamforming structure from the perspective of transceiver units (TXRUs) and physical antennas according to the present invention;

FIG. 10 is a diagram schematically illustrating an exemplary beam sweeping operation for a synchronization signal and system information in a downlink (DL) transmission procedure according to the present invention;

FIG. 11 is a diagram illustrating three examples according to whether a resource region and a UL control subband in which an NR-PUCCH applicable to the present invention is transmitted is configured;

FIG. 12 is a flowchart illustrating a PUCCH transmission method for a UE according to an embodiment of the present invention;

FIG. 13 is a diagram showing a configuration of a UE and a base station in which the proposed embodiments may be implemented.

### BEST MODE

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

Throughout the specification, when a certain portion “includes” or “comprises” a certain component, this indicates that other components are not excluded and may be further included unless otherwise noted. The terms “unit”, “-or/er” and “module” used in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a User Equipment (UE). A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an evolved Node B (eNode B or eNB), an Advanced Base Station (ABS), new generation Node B (gNB), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmission end is a fixed and/or mobile node that provides a data service or a voice service and a reception end is a fixed and/or mobile node that receives a data service or a voice service. Therefore, a UE may serve as a transmission end and a BS may serve as a reception end, on an UpLink (UL). Likewise, the UE may serve as a reception end and the BS may serve as a transmission end, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331. That is, the steps or parts, which are not described to clearly reveal the technical idea of the present disclosure, in the embodiments of the present disclosure may be explained by the above standard specifications. All terms used in the embodiments of the present disclosure may be explained by the standard specifications.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

For example, the term, TxOP may be used interchangeably with transmission period or Reserved Resource Period (RRP) in the same sense. Further, a Listen-Before-Talk (LBT) procedure may be performed for the same purpose as a carrier sensing procedure for determining whether a channel state is idle or busy, CCA (Clear Channel Assessment), CAP (Channel Access Procedure).

Hereinafter, 3GPP LTE/LTE-A systems are explained, which are examples of wireless access systems.

The embodiments of the present disclosure can be applied to various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc.

UTRA is a part of Universal Mobile Telecommunications System (UMTS). 3GPP LTE is a part of Evolved UMTS (E-UMTS) using E-UTRA, adopting OFDMA for DL and SC-FDMA for UL. LTE-Advanced (LTE-A) is an evolution of 3GPP LTE. While the embodiments of the present disclosure are described in the context of a 3GPP LTE/LTE-A system in order to clarify the technical features of the present disclosure, the present disclosure is also applicable to an IEEE 802.16e/m system, etc.

### 1. 3GPP LTE/LTE-A System

1.1. Physical Channels and Signal Transmission and Reception Method Using the Same

In a wireless access system, a UE receives information from an eNB on a DL and transmits information to the eNB on a UL. The information transmitted and received between the UE and the eNB includes general data information and various types of control information. There are many physical channels according to the types/usages of information transmitted and received between the eNB and the UE.

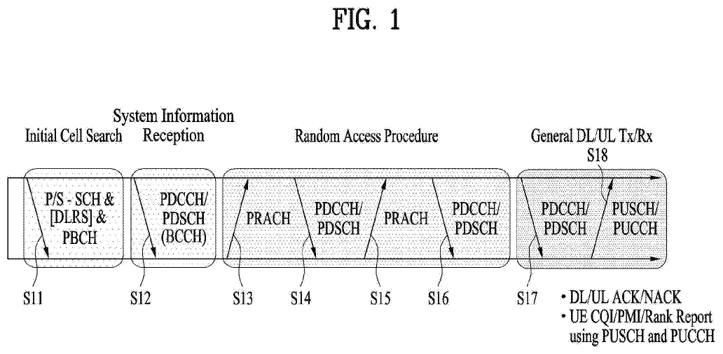

FIG. 1 illustrates physical channels and a general signal transmission method using the physical channels, which may be used in embodiments of the present disclosure.

When a UE is powered on or enters a new cell, the UE performs initial cell search (S11). The initial cell search involves acquisition of synchronization to an eNB. Specifically, the UE synchronizes its timing to the eNB and acquires information such as a cell Identifier (ID) by receiving a Primary Synchronization Channel (P-SCH) and a Secondary Synchronization Channel (S-SCH) from the eNB.

Then the UE may acquire information broadcast in the cell by receiving a Physical Broadcast Channel (PBCH) from the eNB.

During the initial cell search, the UE may monitor a DL channel state by receiving a Downlink Reference Signal (DL RS).

After the initial cell search, the UE may acquire more detailed system information by receiving a Physical Downlink Control Channel (PDCCH) and receiving a Physical Downlink Shared Channel (PDSCH) based on information of the PDCCH (S12).

Then, to complete connection to the eNB, the UE may perform a random access procedure with the eNB (S13 to S16). In the random access procedure, the UE may transmit a preamble on a Physical Random Access Channel (PRACH) (S13) and may receive a PDCCH and a PDSCH associated with the PDCCH (S14). In the case of contention-based random access, the UE may additionally perform a contention resolution procedure including transmission of an additional PRACH (S15) and reception of a PDCCH signal and a PDSCH signal corresponding to the PDCCH signal (S16).

After the above procedure, the UE may receive a PDCCH and/or a PDSCH from the eNB (S17) and transmit a Physical Uplink Shared Channel (PUSCH) and/or a Physical Uplink Control Channel (PUCCH) to the eNB (S18), in a general UL/DL signal transmission procedure.

Control information that the UE transmits to the eNB is generically called Uplink Control Information (UCI). The UCI includes a Hybrid Automatic Repeat and reQuest Acknowledgement/Negative Acknowledgement (HARQ-ACK/NACK), a Scheduling Request (SR), a Channel Quality Indicator (CQI), a Precoding Matrix Index (PMI), a Rank Indicator (RI), etc.

In the LTE system, UCI is generally transmitted on a PUCCH periodically. However, if control information and traffic data should be transmitted simultaneously, the control information and traffic data may be transmitted on a PUSCH. In addition, the UCI may be transmitted aperiodically on the PUSCH, upon receipt of a request/command from a network.

1.2. Resource Structure

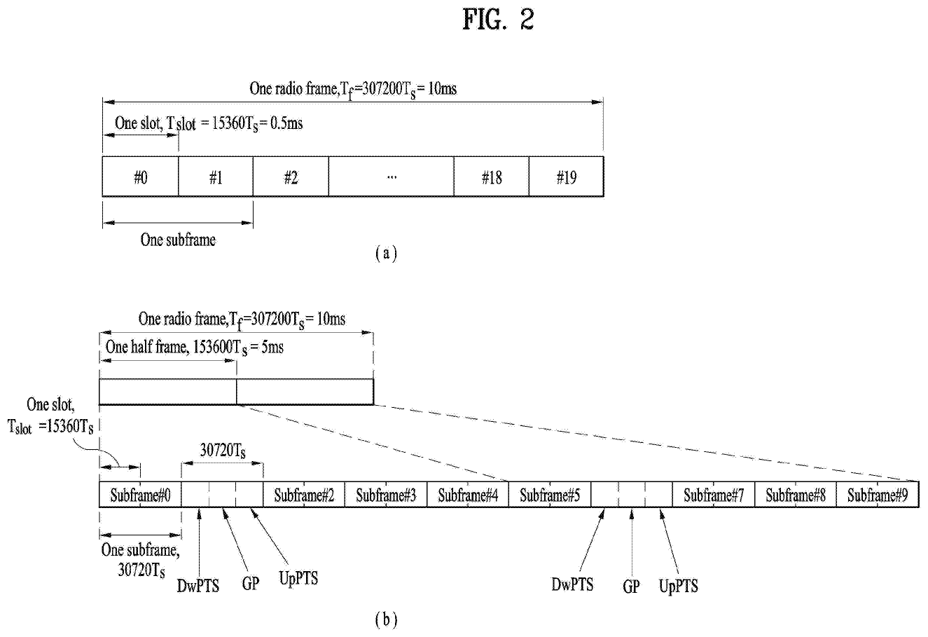

FIG. 2 illustrates exemplary radio frame structures used in embodiments of the present disclosure.

FIG. 2(a) illustrates frame structure type 1. Frame structure type 1 is applicable to both a full Frequency Division Duplex (FDD) system and a half FDD system.

One radio frame is 10 ms (T_{f}=307200·Tₛ) long, including equal-sized 20 slots indexed from 0 to 19. Each slot is 0.5 ms (Tₛₗₒₜ=15360·Tₛ) long. One subframe includes two successive slots. An ith subframe includes 2ith and (2i+1)th slots. That is, a radio frame includes 10 subframes. A time required for transmitting one subframe is defined as a Transmission Time Interval (TTI). Tₛ is a sampling time given as Tₛ=1/(15 kHz×2048)=3.2552×10⁻⁸ (about 33 ns). One slot includes a plurality of Orthogonal Frequency Division Multiplexing (OFDM) symbols or SC-FDMA symbols in the time domain by a plurality of Resource Blocks (RBs) in the frequency domain.

A slot includes a plurality of OFDM symbols in the time domain. Since OFDMA is adopted for DL in the 3GPP LTE system, one OFDM symbol represents one symbol period. An OFDM symbol may be called an SC-FDMA symbol or symbol period. An RB is a resource allocation unit including a plurality of contiguous subcarriers in one slot.

In a full FDD system, each of 10 subframes may be used simultaneously for DL transmission and UL transmission during a 10-ms duration. The DL transmission and the UL transmission are distinguished by frequency. On the other hand, a UE cannot perform transmission and reception simultaneously in a half FDD system.

The above radio frame structure is purely exemplary. Thus, the number of subframes in a radio frame, the number of slots in a subframe, and the number of OFDM symbols in a slot may be changed.

FIG. 2(b) illustrates frame structure type 2. Frame structure type 2 is applied to a Time Division Duplex (TDD) system. One radio frame is 10 ms (T_{f}=307200·Tₛ) long, including two half-frames each having a length of 5 ms (=153600·Tₛ) long. Each half-frame includes five subframes each being 1 ms (=30720·Tₛ) long. An ith subframe includes 2ith and (2i+1)th slots each having a length of 0.5 ms (Tₛₗₒₜ=15360·Tₛ). Tₛ is a sampling time given as Tₛ=1/(15 kHz×2048)=3.2552×10⁻⁸ (about 33 ns).

A type-2 frame includes a special subframe having three fields, Downlink Pilot Time Slot (DwPTS), Guard Period (GP), and Uplink Pilot Time Slot (UpPTS). The DwPTS is used for initial cell search, synchronization, or channel estimation at a UE, and the UpPTS is used for channel estimation and UL transmission synchronization with a UE at an eNB. The GP is used to cancel UL interference between a UL and a DL, caused by the multi-path delay of a DL signal.

Table 1 below lists special subframe configurations (DwPTS/GP/UpPTS lengths).

TABLE 1

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

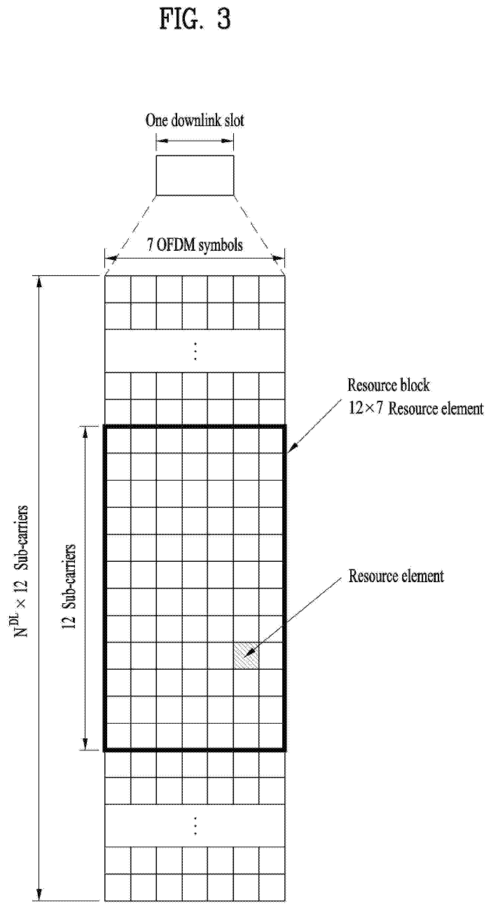

FIG. 3 illustrates an exemplary structure of a DL resource grid for the duration of one DL slot, which may be used in embodiments of the present disclosure.

Referring to FIG. 3, a DL slot includes a plurality of OFDM symbols in the time domain. One DL slot includes 7 OFDM symbols in the time domain and an RB includes 12 subcarriers in the frequency domain, to which the present disclosure is not limited.

Each element of the resource grid is referred to as a Resource Element (RE). An RB includes 12×7 REs. The number of RBs in a DL slot, NDL depends on a DL transmission bandwidth. The structure of the uplink slot may be the same as the structure of the downlink slot.

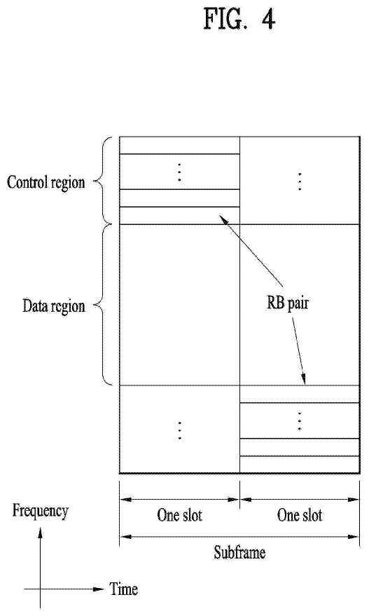

FIG. 4 illustrates a structure of a UL subframe which may be used in embodiments of the present disclosure.

Referring to FIG. 4, a UL subframe may be divided into a control region and a data region in the frequency domain. A PUCCH carrying UCI is allocated to the control region and a PUSCH carrying user data is allocated to the data region. To maintain a single carrier property, a UE does not transmit a PUCCH and a PUSCH simultaneously. A pair of RBs in a subframe are allocated to a PUCCH for a UE. The RBs of the RB pair occupy different subcarriers in two slots. Thus it is said that the RB pair frequency-hops over a slot boundary.

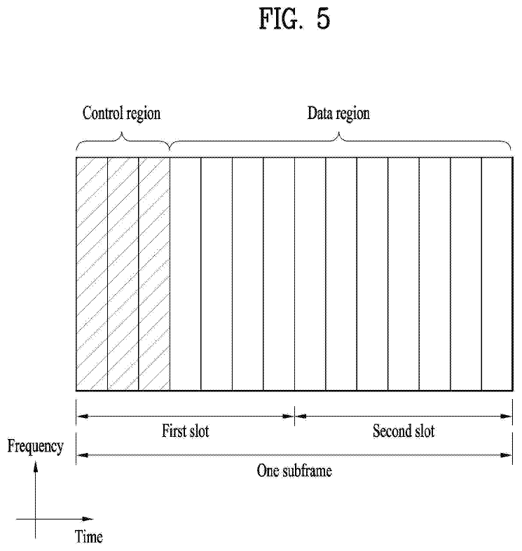

FIG. 5 illustrates a structure of a DL subframe that may be used in embodiments of the present disclosure.

Referring to FIG. 5, up to three OFDM symbols of a DL subframe, starting from OFDM symbol 0 are used as a control region to which control channels are allocated and the other OFDM symbols of the DL subframe are used as a data region to which a PDSCH is allocated. DL control channels defined for the 3GPP LTE system include a Physical Control Format Indicator Channel (PCFICH), a PDCCH, and a Physical Hybrid ARQ Indicator Channel (PHICH).

The PCFICH is transmitted in the first OFDM symbol of a subframe, carrying information about the number of OFDM symbols used for transmission of control channels (i.e., the size of the control region) in the subframe. The PHICH is a response channel to a UL transmission, delivering an HARQ ACK/NACK signal. Control information carried on the PDCCH is called Downlink Control Information (DCI). The DCI transports UL resource assignment information, DL resource assignment information, or UL Transmission (Tx) power control commands for a UE group.

1.3. CSI Feedback

In the 3GPP LTE or LTE-A system, user equipment (UE) has been defined to report channel state information (CSI) to a base station (BS or eNB). Herein, the CSI refers to information indicating the quality of a radio channel (or link) formed between the UE and an antenna port.

For example, the CSI may include a rank indicator (RI), a precoding matrix indicator (PMI), and a channel quality indicator (CQI).

Here, RI denotes rank information about the corresponding channel, which means the number of streams that the UE receives through the same time-frequency resource. This value is determined depending on the channel's Long Term Fading. Subsequently, the RI may be fed back to the BS by the UE, usually at a longer periodic interval than the PMI or CQI.

The PMI is a value reflecting the characteristics of a channel space and indicates a precoding index preferred by the UE based on a metric such as SINR.

The CQI is a value indicating the strength of a channel, and generally refers to a reception SINR that can be obtained when the BS uses the PMI.

In the 3GPP LTE or LTE-A system, the base station may set a plurality of CSI processes for the UE, and receive a report of the CSI for each process from the UE. Here, the CSI process is configured with a CSI-RS for specifying signal quality from the base station and a CSI-interference measurement (CSI-IM) resource for interference measurement.

1.4. RRM Measurement

The LTE system supports Radio Resource Management (RRM) operation including power control, scheduling, cell search, cell reselection, handover, radio link or connection monitoring, and connection establishment/re-establishment. In this case, a serving cell may request a UE to send RRM measurement information, which contains measurement values for performing the RRM operation. As a representative example, in the LTE system, the UE may measure cell search information, Reference Signal Received Power (RSRP), Reference Signal Received Quality (RSRQ), etc. for each cell and then report the measured information. Specifically, in the LTE system, the UE receives ‘measConfig’ for the RRM measurement from the serving cell through a higher layer signal and then measure RSRP or RSRQ according to information in ‘measConfig’.

In the LTE system, the RSRP, RSRQ, and RSSI has been defined as follows.

The RSRP is defined as the linear average over the power contributions (in [W]) of the resource elements that carry cell-specific reference signals within the considered measurement frequency bandwidth. For example, for RSRP determination, the cell-specific reference signals R₀ shall be used. For RSRP determination, the cell-specific reference signals R₀ shall be used. If the UE can reliably detect that R₁ is available, it may use R₁ in addition to R₀ to determine RSRP.

The reference point for the RSRP shall be the antenna connector of the UE.

If receiver diversity is in use by the UE, the reported value shall not be lower than the corresponding RSRP of any of the individual diversity branches.

The RSRQ is defined as the ratio N×RSRP/(E-UTRA carrier RSSI), where N is the number of RBs of the E-UTRA carrier RSSI measurement bandwidth. The measurements in the numerator and denominator shall be made over the same set of resource blocks.

The E-UTRA carrier RSSI comprises the linear average of the total received power (in [W]) observed only in OFDM symbols containing reference symbols for antenna port 0, in the measurement bandwidth, over N number of resource blocks by the UE from all sources, including co-channel serving and non-serving cells, adjacent channel interference, thermal noise etc. If higher-layer signaling indicates certain subframes for performing RSRQ measurements, then RSSI is measured over all OFDM symbols in the indicated subframes.

The reference point for the RSRQ shall be the antenna connector of the UE.

If receiver diversity is in use by the UE, the reported value shall not be lower than the corresponding RSRQ of any of the individual diversity branches.

The RSSI is defined as the received wide band power, including thermal noise and noise generated in the receiver, within the bandwidth defined by the receiver pulse shaping filter.

The reference point for the measurement shall be the antenna connector of the UE.

If receiver diversity is in use by the UE, the reported value shall not be lower than the corresponding UTRA carrier RSSI of any of the individual receive antenna branches.

Based on the above-described definitions, in the case of intra-frequency measurement, a UE operating in the LTE system may measure the RSRP in a bandwidth indicated by an allowed measurement bandwidth related information element (IE) transmitted in system information block type 3 (SIB3). Meanwhile, in the case of inter-frequency measurement, the UE may measure the RSRP in a bandwidth corresponding to one of 6, 15, 25, 50, 75, 100 resource blocks (RBs) indicated by an allowed measurement bandwidth related IE transmitted in SIB5. Alternatively, if there is no IE, the UE may measure the RSRP in the entire downlink (DL) system frequency bandwidth as the default operation.

Upon receiving information on the allowed measurement bandwidth, the UE may regard the corresponding value as the maximum measurement bandwidth and then freely measure the RSRP value within the corresponding value. However, if the serving cell transmits an IE defined as WB-RSRQ to the UE and sets the allowed measurement bandwidth to be equal to or greater than 50 RBs, the UE should calculate the RSRP value for the entire allowed measurement bandwidth. Meanwhile, when intending to the RSSI, the UE measures the RSSI using a frequency band of the UE's receiver according to the definition of RSSI bandwidth.

### 2. New Radio Access Technology System

As more and more communication devices require greater communication capacity, there is a need for mobile broadband communication enhanced over existing radio access technology (RAT). In addition, massive Machine-Type Communications (MTC) capable of providing a variety of services anywhere and anytime by connecting multiple devices and objects is also considered. Communication system design considering services/UEs sensitive to reliability and latency is also under discussion.

As such, introduction of new radio access technology considering enhanced mobile broadband communication, massive MTC, and Ultra-Reliable and Low Latency Communication (URLLC) is being discussed. In the present invention, for simplicity, this technology will be referred to as New RAT or NR (New Radio).

2.1. Self-Contained Subframe Structure

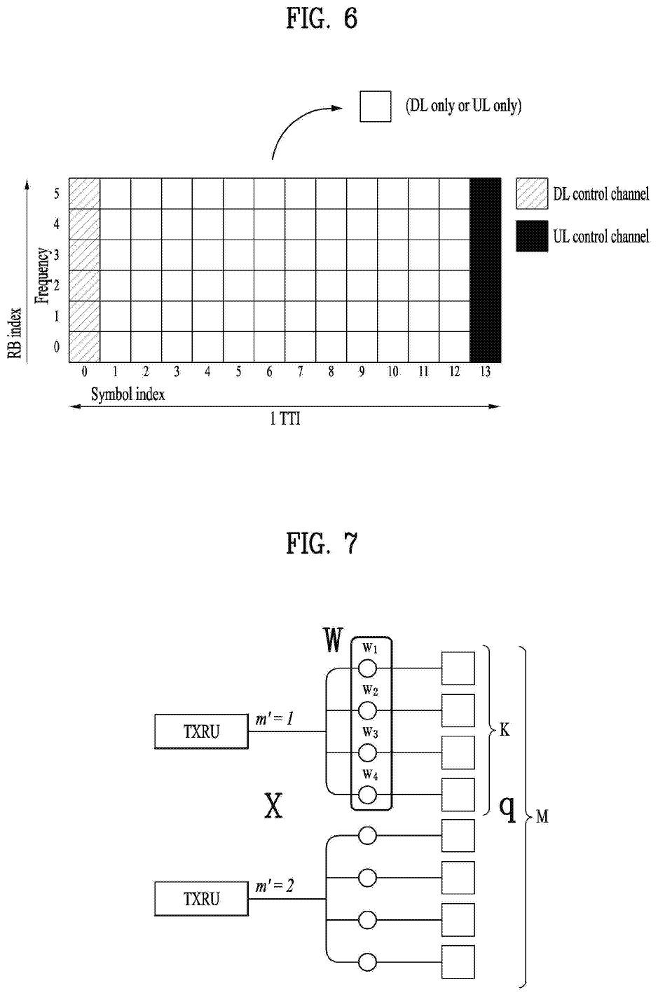

FIG. 6 is a diagram illustrating a self-contained subframe structure applicable to the present invention.

In the NR system to which the present invention is applicable, a self-contained subframe structure as shown in FIG. 6 is proposed in order to minimize data transmission latency in the TDD system.

In FIG. 6, the hatched region (e.g., symbol index=0) represents a downlink control region, and the black region (e.g., symbol index=13) represents an uplink control region. The other region (e.g., symbol index=1 to 12) may be used for downlink data transmission or for uplink data transmission.

In this structure, DL transmission and UL transmission may be sequentially performed in one subframe. In addition, DL data may be transmitted and received in one subframe and UL ACK/NACK therefor may be transmitted and received in the same subframe. As a result, this structure may reduce time taken to retransmit data when a data transmission error occurs, thereby minimizing the latency of final data transmission.

In such a self-contained subframe structure, a time gap having a certain temporal length is required in order for the base station and the UE to switch from the transmission mode to the reception mode or from the reception mode to the transmission mode. To this end, some OFDM symbols at the time of switching from DL to UL in the self-contained subframe structure may be set as a guard period (GP).

While a case where the self-contained subframe structure includes both the DL control region and the UL control region has been described above, the control regions may be selectively included in the self-contained subframe structure. In other words, the self-contained subframe structure according to the present invention may include not only the case of including both the DL control region and the UL control region but also the case of including either the DL control region or the UL control region alone, as shown in FIG. 6.

For simplicity of explanation, the frame structure configured as above is referred to as a subframe, but this configuration can also be referred to as a frame or a slot. For example, in the NR system, one unit consisting of a plurality of symbols may be referred to as a slot. In the following description, a subframe or a frame may be replaced with the slot described above.

2.2. OFDM Numerology

The NR system uses the OFDM transmission scheme or a similar transmission scheme. The NR system may have an OFDM numerology as shown in Table 2 as a representative numerology.

TABLE 2

| Parameter | Value | |
|---|---|---|
| Subcarrier-spacing (Δf) | 75 | kHz |
| OFDM symbol length | 13.33 | μs |
| Cyclic Prefix (CP) length | 1.04 μs/0.94 μs | |
| System BW | 100 | MHz |
| No. of available subcarriers | 1200 | |
| Subframe length | 0.2 | ms |
| Number of OFDM symbol per Subframe | 14 | symbols |

Alternatively, the NR system may use the OFDM transmission scheme or a similar transmission scheme, and may use an OFDM numerology selected from among multiple OFDM numerologies as shown in Table 3. Specifically, as disclosed in Table 3, the NR system may take the 15 kHz subcarrier-spacing used in the LTE system as a base, and use an OFDM numerology having subcarrier-spacing of 30, 60, and 120 kHz, which are multiples of the 15 kHz subcarrier-spacing.

In this case, the cyclic prefix, the system bandwidth (BW) and the number of available subcarriers disclosed in Table 3 are merely an example that is applicable to the NR system according to the present invention, and the values thereof may depend on the implementation method. Typically, for the 60 kHz subcarrier-spacing, the system bandwidth may be set to 100 MHz. In this case, the number of available subcarriers may be greater than 1500 and less than 1666. Also, the subframe length and the number of OFDM symbols per subframe disclosed in Table 3 are merely an example that is applicable to the NR system according to the present invention, and the values thereof may depend on the implementation method.

TABLE 3

| Parameter | Value | | Value | | Value | | Value | |
|---|---|---|---|---|---|---|---|---|
| Subcarrier-spacing | 15 | kHz | 30 | kHz | 60 | kHz | 120 | kHz |
| (Δf) | | | | | | | | |
| OFDM symbol | 66.66 | | 33.33 | | 16.66 | | 8.33 | |
| length | | | | | | | | |
| Cyclic Prefix (CP) | 5.20 μs/ | | 2.60 μs/ | | 1.30 μs/ | | 0.65 μs/ | |
| length | 4.69 μs | | 2.34 μs | | 1.17 μs | | 0.59 μs | |
| System BW | 20 | MHz | 40 | MHz | 80 | MHz | 160 | MHz |
| No. of available | 1200 | | 1200 | | 1200 | | 1200 | |
| subcarriers | | | | | | | | |
| Subframe length | 1 | ms | 0.5 | ms | 0.25 | ms | 0.125 | ms |

| | | | | |
|---|---|---|---|---|
| Number of OFDM | 14 | 14 | 14 | 14 |
| symbol per Sub- | symbols | symbols | symbols | symbols |
| frame | | | | |

2.3. Analog Beamforming

In a millimeter wave (mmW) system, since a wavelength is short, a plurality of antenna elements can be installed in the same area. That is, considering that the wavelength at 30 GHz band is 1 cm, a total of 100 antenna elements can be installed in a 5 [symbol] 5 cm panel at intervals of 0.5 lambda (wavelength) in the case of a 2-dimensional array. Therefore, in the mmW system, it is possible to improve the coverage or throughput by increasing the beamforming (BF) gain using multiple antenna elements.

In this case, each antenna element can include a transceiver unit (TXRU) to enable adjustment of transmit power and phase per antenna element. By doing so, each antenna element can perform independent beamforming per frequency resource.

However, installing TXRUs in all of the about 100 antenna elements is less feasible in terms of cost. Therefore, a method of mapping a plurality of antenna elements to one TXRU and adjusting the direction of a beam using an analog phase shifter has been considered. However, this method is disadvantageous in that frequency selective beamforming is impossible because only one beam direction is generated over the full band.

To solve this problem, as an intermediate form of digital BF and analog BF, hybrid BF with B TXRUs that are fewer than Q antenna elements can be considered. In the case of the hybrid BF, the number of beam directions that can be transmitted at the same time is limited to B or less, which depends on how B TXRUs and Q antenna elements are connected.

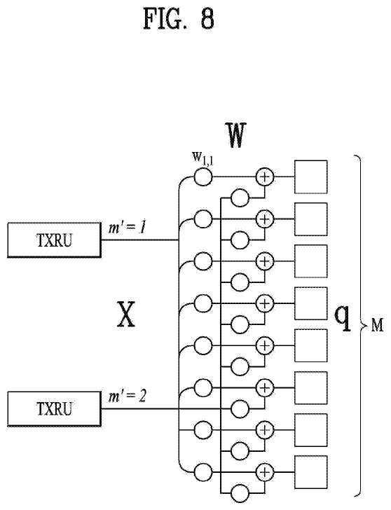

FIGS. 7 and 8 are diagrams illustrating representative methods for connecting TXRUs to antenna elements. Here, the TXRU virtualization model represents the relationship between TXRU output signals and antenna element output signals.

FIG. 7 shows a method for connecting TXRUs to sub-arrays. In FIG. 7, one antenna element is connected to one TXRU.

FIG. 8 shows a method for connecting all TXRUs to all antenna elements. In FIG. 8, all antenna element are connected to all TXRUs. In this case, separate addition units are required to connect all antenna elements to all TXRUs as shown in FIG. 8.

In FIGS. 7 and 8, W indicates a phase vector weighted by an analog phase shifter. That is, W is a major parameter determining the direction of the analog beamforming. In this case, the mapping relationship between CSI-RS antenna ports and TXRUs may be 1:1 or 1-to-many.

The configuration shown in FIG. 7 has a disadvantage in that it is difficult to achieve beamforming focusing but has an advantage in that all antennas can be configured at low cost.

On the contrary, the configuration shown in FIG. 8 is advantageous in that beamforming focusing can be easily achieved. However, since all antenna elements are connected to the TXRU, it has a disadvantage of high cost.

When a plurality of antennas is used in the NR system to which the present invention is applicable, a hybrid beamforming (BF) scheme in which digital BF and analog BF are combined may be applied. In this case, analog BF (or radio frequency (RF) BF) means an operation of performing precoding (or combining) at an RF stage. In hybrid BF, each of a baseband stage and the RF stage perform precoding (or combining) and, therefore, performance approximating to digital BF can be achieved while reducing the number of RF chains and the number of a digital-to-analog (D/A) (or analog-to-digital (A/D) converters.

For convenience of description, a hybrid BF structure may be represented by N transceiver units (TXRUs) and M physical antennas. In this case, digital BF for L data layers to be transmitted by a transmission end may be represented by an N-by-L matrix. N converted digital signals obtained thereafter are converted into analog signals via the TXRUs and then subjected to analog BF, which is represented by an M-by-N matrix.

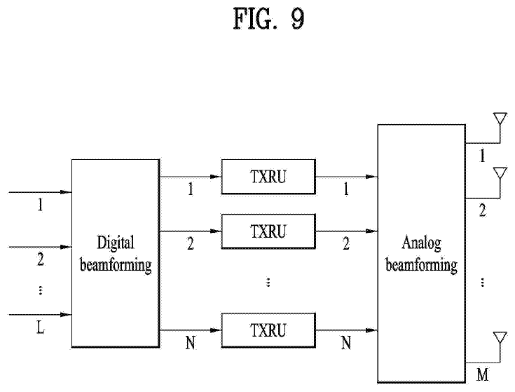

FIG. 9 is a diagram schematically illustrating an exemplary hybrid BF structure from the perspective of TXRUs and physical antennas according to the present invention. In FIG. 9, the number of digital beams is L and the number analog beams is N.

Additionally, in the NR system to which the present invention is applicable, an eNB designs analog BF to be changed in units of symbols to provide more efficient BF support to a UE located in a specific area. Furthermore, as illustrated in FIG. 9, when N specific TXRUs and M RF antennas are defined as one antenna panel, the NR system according to the present invention considers introducing a plurality of antenna panels to which independent hybrid BF is applicable.

In the case in which the eNB utilizes a plurality of analog beams as described above, the analog beams advantageous for signal reception may differ according to a UE. Therefore, in the NR system to which the present invention is applicable, a beam sweeping operation is being considered in which the eNB transmits signals (at least synchronization signals, system information, paging, and the like) by applying different analog beams in a specific subframe (SF) on a symbol-by-symbol basis so that all UEs may have reception opportunities.

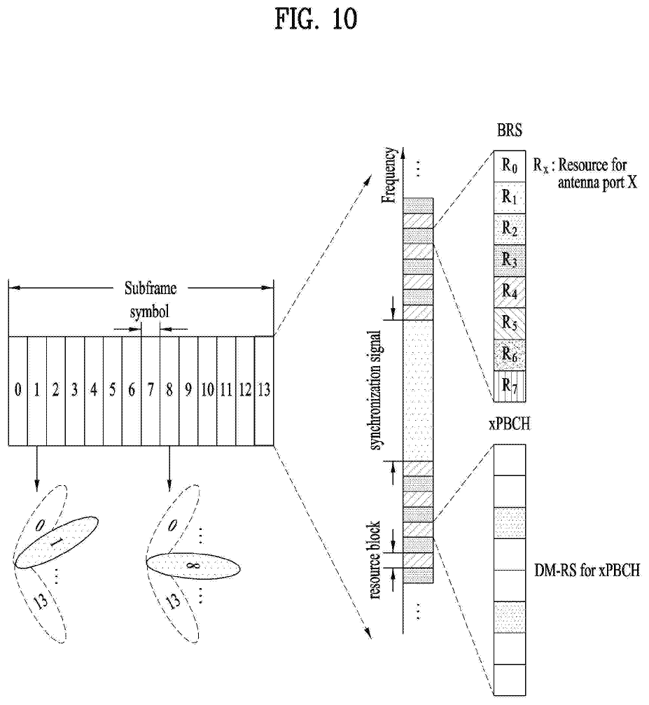

FIG. 10 is a diagram schematically illustrating an exemplary beam sweeping operation for a synchronization signal and system information in a DL transmission procedure according to the present invention.

In FIG. 10 below, a physical resource (or physical channel) on which the system information of the NR system to which the present invention is applicable is transmitted in a broadcasting manner is referred to as an xPBCH. Here, analog beams belonging to different antenna panels within one symbol may be simultaneously transmitted.

As illustrated in FIG. 10, in order to measure a channel for each analog beam in the NR system to which the present invention is applicable, introducing a beam RS (BRS), which is a reference signal (RS) transmitted by applying a single analog beam (corresponding to a specific antenna panel), is being discussed. The BRS may be defined for a plurality of antenna ports and each antenna port of the BRS may correspond to a single analog beam. In this case, unlike the BRS, a synchronization signal or the xPBCH may be transmitted by applying all analog beams in an analog beam group such that any UE may receive the signal well.

### 3. Proposed Embodiments

Hereinafter, configurations proposed in the present invention based on the above technical description will be described in detail.

Hereinafter, a method for determining a resource for uplink control channel (NR-PUCCH) transmission supported by the NR system to which the present invention is applicable, and an NR-PUCCH transmission/reception method based thereon will be described in detail.

In the NR system to which the present invention is applicable, a UE-specific or cell-specific control subband may be defined for the DL control channel (NR-PDCCH) and the UL control channel in the frequency domain. Here, the control subband may be set to be equal to or narrower than the entire system band or a UE specific band. For example, the control subband may be composed of groups in a unit of resource block consisting of 12 subcarriers.

In addition, one control subband may be contiguously or non-contiguously configured on the frequency axis.

One or more control subbands may be configured for a specific UE, and one control subband may be shared by multiple UEs.

In addition, a DL control subband and a UL control subband may be configured separately for a specific UE. However, there may be a constraint that one NR-PDCCH (or one NR-PUCCH) shall be transmitted within one DL control subband (or one UL control subband).

Hereinafter, a method for determining a UL control subband for NR-PUCCH transmission and a method for determining resources for NR-PUCCH transmission within the determined UL control subband will be described in more detail. Then, a method for multiplexing between a UL control subband and an NR-PUSCH will be described in detail.

3.1. UL Control Subband Determination Method

3.1.1. First UL Control Subband Determination Method (Semi-Static Configuration)

A UE-specific UL control subband may be preconfigured semi-statically (e.g., by RRC signaling or so as to be equal to the UE specific bandwidth). Here, multiple UL control subbands may be configured in consideration of flexibility of the NR-PUCCH transmission region.

3.1.2. Second UL Control Subband Determination Method (Dynamic Indication)

In the case where multiple UL control subbands are semi-statistically configured as in the first UL control subband determination method described above, the gNB may dynamically indicate a UL control subband (or multiple UL control subbands) in which the corresponding NR-PUCCH is to be transmitted, through L1 signaling (e.g., DCI for scheduling DL data) (in a manner similar to the ACK/NACK Resource Indicator (ARI) scheme of the LTE system).

As a more specific example, the gNB may configure a plurality of UL control subbands through higher layer signaling and dynamically indicate, through separate L1 signaling, a UL control subband in which the NR-PUCCH is to be transmitted.

3.1.3. Third UL Control Subband Determination Method (Configuration of Implicit Linkage with DL Control Subband)

In the case where a one-to-one mapping relationship is pre-established between DL control subbands and UL control subbands, a UL control subband in which the NR-PUCCH is to be transmitted may be determined based on a DL control subband in which DCI for scheduling DL data has been actually transmitted. Similarly, in the case where a one-to-multiple (or multiple-to-one) mapping relationship is pre-established between DL control subbands and UL control subbands and there are multiple UL control subbands corresponding to one DL control subband, a subband in which the UE should transmit the NR-PUCCH among the multiple UL control subbands may be explicitly signaled through the DCI for scheduling DL data.

3.2. Method for Determining NR-PUCCH Resources in UL Control Subband

When the UE receiving DL data determines UL control subband(s) in which the UE is to transmit the corresponding NR-PUCCH according to section 3.1, the UE may specifically determine an NR-PUCCH resource to be used to transmit the NR-PUCCH.

In the case of PUCCH formats 1/1a/1b supported by the legacy LTE system, the PUCCH resource index is configured as a function of the PDCCH lowest Control Channel Element (CCE) index. In addition, the PUCCH resource index is determined by a combination of a PRB index, an Orthogonal Cover Code (OCC), a cyclic shift (CS), and the like.

Similarly, in the NR system to which the present invention is applicable, the PUCCH resource index may be configured as a function of the PDCCH lowest CCE index or the PDSCH lowest CCE index. In this case, one NR-PUCCH resource index may be determined by a combination of a symbol index, a symbol duration, a UL control subband index, and the like, which are for transmission of the PUCCH, as well as a PRB index, an OCC, and a cyclic shift.

Hereinafter, methods for determining an NR-PUCCH resource index (which may be determined by a combination of, for example, a PRB index, an OCC, a cyclic shift, a symbol index on which a PUCCH is transmitted, a symbol duration, a UL control subband index, and the like) corresponding to a DL control resource index (which may be configured as a function of, for example, a PDCCH lowest CCE index or a PDSCH lowest CCE index) will be described from a more general prospective.

3.2.1. First NR-PUCCH Resource Determination Method (when there is One UL Control Subband Determined)

One UL control subband may be allocated to a specific UE as in the first UL control subband determination method described above, may be indicated through DCI for scheduling DL data as in the second UL control subband determination method, may be determined by a one-to-one relationship as in the third UL control subband determination method, or may be determined by a one-to-multiple mapping relationship as in the third UL control subband determination method. That is, when one UL control subband is determined, the number of DL control subband candidates corresponding thereto may be greater than or equal to 1.

In addition, the DL control resource indexes and the NR-PUCCH resource indexes may have a one-to-one mapping relationship irrespective of the corresponding DL control subband candidates.

As an example, when DL control subband #0 and DL control subband #1 are allocated to a specific UE, DL control resource indexes #0 to #49 may be mapped to DL control subband #0, and DL control resource indexes #50 to #99 may be mapped to DL control subband #1.

In addition, NR-PUCCH resource indexes #0 to #99 may be configured for UL control subband #0 corresponding to DL control subband #0 and DL control subband #1. In this case, NR-PUCCH resource index #k may be configured as an NR-PUCCH resource index corresponding to DL control resource index #k by the one-to-one mapping relationship between the DL control resource indexes and the NR-PUCCH resource indexes.

Alternatively, the DL control resource indexes may have a one-to-multiple mapping relationship with the NR-PUCCH resource indexes when a plurality of corresponding DL control subband candidates is present (or irrespective of the number of the candidates).

As an example, when DL control subband #0 and DL control subband #1 are allocated to a specific UE, DL control resource indexes #0 to #49 may be mapped to DL control subband #0, and DL control resource indexes #0 to #49 may be mapped to DL control subband #1. In addition, NR-PUCCH resource indexes #0 to #49 may correspond to UL control subband #0, which corresponds to DL control subband #0 and DL control subband #1.

In this case, NR-PUCCH resource index #k may be configured as an NR-PUCCH resource index corresponding to DL control resource index #k in DL control subband #0 or #1 by the multiple-to-one mapping relationship between the DL control resource indexes and the NR-PUCCH resource indexes.

When DCIs are simultaneously transmitted to the UE on DL control resource index #k in DL control subband #0 and DL control resource index #k in DL control subband #1, collision may occur between the NR-PUCCH resources. In this case, a (pre-set or signaled) offset value may be applied to the NR-PUCCH resource corresponding to DL control resource index #k in DL control subband #1 (and/or DL control subband #0), or HARQ-ACKs may be bundled and transmitted.

3.2.2. Second NR-PUCCH Resource Determination Method (when a Plurality of UL Control Subbands is Determined)

A plurality of UL control subbands may be allocated to a specific UE as in the first UL control subband determination method described above, may be indicated through DCI for scheduling DL data as in the second UL control subband determination method, or may be determined by a one-to-multiple mapping relationship as in the third UL control subband determination method. That is, when a plurality of UL control subbands is determined, there may be one or more DL control subband candidates corresponding thereto.

In addition, the DL control resource indexes may have a one-to-one mapping relationship with the NR-PUCCH resource indexes irrespective of the corresponding DL control subband candidates.

As an example, when DL control subband #0 is allocated to a specific UE, DL control resource indexes #0 to #99 may be mapped according to DL control subband #0.

In addition, NR-PUCCH resource indexes #0 to #49 (for UL control subband #0) and NR-PUCCH resource indexes #50˜#99 (for UL control subband #1) may be configured in UL control subband #0 and UL control subband #1 corresponding to DL control subband #0. In this case, NR-PUCCH resource index #k may be configured as an NR-PUCCH resource index corresponding to DL control resource index #k by the one-to-one mapping relationship between the DL control resource indexes and the NR-PUCCH resource indexes.

Alternatively, the DL control resource indexes may have a one-to-multiple mapping relationship with the NR-PUCCH resource indexes when the number of corresponding DL control subband candidates is 1 (or irrespective of the number of the candidates).

As an example, when DL control subband #0 is allocated to a specific UE, DL control resource indexes #0 to #49 may be configured according to DL control subband #0.

NR-PUCCH resource indexes #0 to #49 (for UL control subband #0) and NR-PUCCH resource indexes #0 to #49 (for UL control subband #1) may be configured in UL control subband #0 and UL control subband #1, which correspond to DL control subband #0. In this case, the NR-PUCCH resource index corresponding to DL control resource index #k in DL control subband #0 may be configured as NR-PUCCH resource index #k in UL control subband #0 and/or UL control subband #1 according to the one-to-multiple mapping relationship between the DL control resource indexes and the NR-PUCCH resource indexes. Here, the NR-PUCCHs may be repetitively transmitted on the NR-PUCCH resource indexes corresponding to one DL control resource index. Alternatively, the UE may perform transmission by arbitrarily selecting one specific NR-PUCCH index or selecting one index according to a predetermined rule. Alternatively, whether the UL control subband in which the UE should transmit the NR-PUCCH may be explicitly signaled through DCI.

3.3. UL Control Subband for NR-PUCCH

In the NR system to which the present invention is applicable, a relatively short PUCCH (hereinafter referred to as a short NR-PUCCH) configured with one symbol or two symbols or a relatively long PUCCH (hereinafter referred to as a long NR-PUCCH) configured with 3 symbols or more may be transmitted in one slot composed of 14 (or 7) symbols. In this case, a UL control subband for the Short NR-PUCCH or Long NR-PUCCH may be configured.

The UL control subband may represent the largest frequency region where frequency hopping of the NR-PUCCH may be performed. In other words, frequency hopping of the NR-PUCCH may be performed with respect to the center frequency of the UL control subband. Here, the UL control subband may be configured to be identical to the maximum system bandwidth of (or the bandwidth of a subband configured for UL data) of the UE, to be narrower than the maximum system bandwidth of the UE, or to be wider larger than the maximum system bandwidth of the UE. When the UL control subband is configured to be different from the maximum system bandwidth of the UE (or the bandwidth of the subband configured for UL data), efficient NR-PUCCH multiplexing (e.g., Code Division Multiplexing (CDM)) between UEs having different bandwidths may be supported.

In the NR system to which the present invention is applicable, up to 400 MHz may be supported per component carrier (CC). In this case, if a UE operating on a wideband CC always operates with the RF for the entire CCs turned on, the battery consumption of the UE may be increased. Further, considering various use cases (e.g., Enhanced Mobile Broadband (eMBB), Ultra Reliable Low Latency Communication (URLLC), massive Machine Type Communication (mMTC), etc.) operating within one wideband CC, different numerologies (e.g., subcarrier spacings, etc.) may be supported for different frequency bands within a specific CC. In addition, the capability for the maximum bandwidth may differ among the UEs.

In consideration of this, the base station may instruct the specific UE to operate only in a partial bandwidth, not the entire bandwidth of the wideband CC. Hereinafter, the partial bandwidth is defined as a bandwidth part (BWP). Here, the BWP may be composed of resource blocks (RBs) contiguous on the frequency axis, and may correspond to one numerology (e.g., subcarrier spacing, CP length, slot/mini-slot duration, etc.).

The base station may configure multiple BWPs in one CC configured for a UE. As an example, in a PDCCH monitoring interval (e.g., a slot), the base station may configure a BWP occupying a relatively small frequency region. For a PDSCH scheduled by the PDCCH, the base station may configure a BWP larger than a BWP configured for the PDCCH. Alternatively, when many UEs are scheduled in a specific BWP, the base station may configure some UEs in another BWP in consideration of load balancing. Alternatively, the base station may exclude a certain spectrum from the entire bandwidth and configure BWPs on both sides in the same slot, in consideration of frequency domain inter-cell interference cancellation between neighboring cells.

That is, the base station may configure at least one (UL) BWP for a UE associated with the broadband CC and activate at least one (UL) BWP of the (UL) BWP(s) configured at a specific time (through L1 signaling or a Medium Access Control (MAC) Control Element (CE) or RRC signaling).

In the present invention, when the UE is in an initial access procedure or is in a situation before an RRC connection is set up, the UE may not receive configuration of a (UL) BWP. Hereinafter, the (UL) BWP assumed by the UE in the above case is defined as an initial active (UL) BWP.

In this section, the term “a subband configured for UL data” may have the same meaning as an active UL BWP or an initial active UL BWP.

In transmitting the PUCCH through the initial active UL BWP or the active UL BWP, the UE may assume that the UL control subband is identical to the initial active UL BWP or the active UL BWP until the UE receives a separate configuration for the UL control subband for the PUCCH.

In addition, in the case where the PUCCH is transmitted in the initial active UL BWP (even if a UL control subband within (wider than) the active UL BWP is allocated), the UE may assume that the UL control subband is identical to the initial active UL BWP. As an example, when the UE transmits HARQ-ACK corresponding to (msg 3 or) msg 4 while performing a Random Access Channel (RACH) procedure in the initial active UL BWP (even if it is assigned a UL control subband within (or wider than) the active UL BWP), it may assume that the UL control subband is identical to the initial active UL BWP.

The configuration proposed in this section is generally applicable to an NR-PUCCH or PUSCH for which frequency hopping is performed.

3.4. Rate Matching Method Considering UL Control Subband for NR-PUCCH

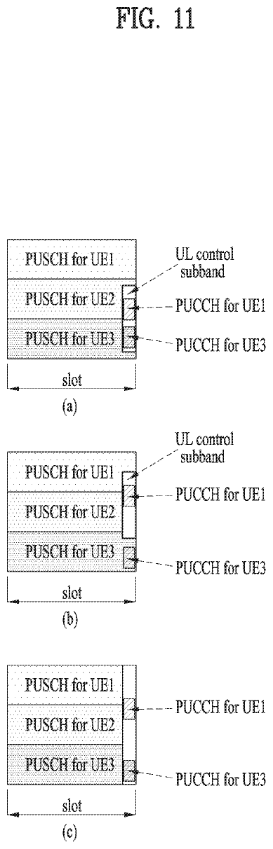

In this section, a rate matching method for transmitting an NR-PUSCH that may be performed by a UE when a UL control subband is configured for an NR-PUCCH will be described in detail. FIG. 11 is a diagram illustrating three examples according to whether a resource region and a UL control subband in which an NR-PUCCH applicable to the present invention is transmitted is configured.

3.4.1. First Rate Matching Method

FIG. 11(a) illustrates a case where the NR-PUCCH is transmitted only within a configured UL control subband region.

When the scheduled NR-PUSCH overlaps with a configured UL control subband region, the UE may always perform rate matching considering the overlapping UL control subband region for the NR-PUSCH. That is, the UE may perform rate matching for the overlapping UL control subband region among the resource regions in which the NR-PUSCH is scheduled.

Alternatively, the gNB may indicate, through a UL grant for the NR-PUSCH, whether to perform rate matching with the UL control subband. In this operation, a control subband index with which rate matching needs to be performed among the configured UL control subband(s) may be indicated. Accordingly, the UE may perform rate matching considering the indicated UL control subband region.

Alternatively, when it is not indicated whether to perform rate matching on a specific control subband index, but the UE transmits an NR-PUCCH in a corresponding UL control subband, the UE may perform puncturing (or rate-matching) on the NR-PUCCH region (or the entire UL control subband region in which the NR-PUCCH is included).

In some implementations, PUCCH resource indexing in the UL control subband(s) may be performed only within the subband, and the method in the above-described section 3.2 may be applied. Alternatively, the PUCCH may be allocated only within the UL control subband(s).

3.4.2. Second Rate Matching Method

FIG. 11(b) illustrates a case where the NR-PUCCH is transmitted within a configured UL control subband region or is allowed to be transmitted outside the region.

In transmitting a scheduled NR-PUSCH, the UE may perform rate matching considering a UL control subband and an NR-PUCCH resource that overlap with each other.

When the NR-PUCCH is transmitted in a region other than the UL control subband, a restriction may be imposed such that NR-PUCCH resources are confined to the NR-PUSCH resource region. With this configuration, the corresponding NR-PUCCH resources may not overlap with the NR-PUSCH resource region of another UE.

Alternatively, the gNB may indicate, through a UL grant for the NR-PUSCH, whether to perform rate matching with the UL control subband. In this operation, a control subband index with which rate matching needs to be performed among the configured UL control subband(s) may be indicated. Accordingly, the UE may perform rate matching considering the indicated UL control subband region.

Alternatively, when it is not indicated whether to perform rate matching on a specific control subband index, but the UE transmits an NR-PUCCH in a corresponding UL control subband, the UE may perform puncturing (or rate matching) on the NR-PUCCH region (or the entire UL control subband region in which the NR-PUCCH is included).

In some implementations, PUCCH resource indexing in the UL control subband(s) may be applied to (or performed in) the maximum system bandwidth of the UE (or the bandwidth of a subband configured for UL data, the system bandwidth of the gNB, or the system bandwidth of the corresponding carrier) irrespective of the subbands. Alternatively, the PUCCH may be allocated to the maximum system bandwidth of the UE (or the bandwidth of a subband configured for UL data, the system bandwidth of the gNB, or the system bandwidth of the corresponding carrier) irrespective of the subbands.

3.4.3. Third Rate Matching Method

FIG. 11C illustrates a case where an NR-PUCCH is transmitted when no UL control subband is configured.

The UE may perform NR-PUSCH rate matching, considering a symbol on which the NR-PUCCH may be transmitted. Such an operation may be implemented by the gNB by indicating the start symbol and/or the end symbol of the NR-PUSCH and/or the PUSCH symbol interval through a UL grant.

As another example, the gNB may configure information indicating that a specific slot is a slot in which a PUCCH is transmitted and/or a PUCCH symbol region (in the slot in which the PUCCH is transmitted) through higher layer signaling or L1 signaling. Thereby, the UE may perform PUSCH rate matching for the configured PUCCH region.

In some implementations, PUCCH resource indexing in the UL control subband(s) may be performed in the maximum system bandwidth of the UE (or the bandwidth of a subband configured for UL data, the system bandwidth of the gNB, or the system bandwidth of the corresponding carrier) irrespective of the subbands

3.5. Signaling Method for Indicating Whether to Perform Rate Matching on NR-PUSCH

Hereinafter, a specific signaling method when it is indicated whether to perform rate matching for a UL control subband through a UL grant for the NR-PUSCH as in the first rate matching method and the second rate matching method described above will be described in detail.

In one example, the gNB may signal whether to perform rate matching (or puncturing) on specific symbol(s) (such as a predefined symbol, the last one symbol in a slot, or the last two symbols in a slot) through a 1-bit indicator in the UL grant. Subsequently, the gNB may signal whether to perform rate matching of the RB or RE level on a specific frequency resource (e.g., UL control subband(s)) within the specific symbol(s) (such as a predefined symbol, the last one symbol in a slot, or the last two symbols in a slot) through an additional 1-bit indicator.

In another example, in order to reduce overhead of signaling through the UL grant, the gNB may indicate whether to perform rate matching (or puncturing) on specific symbol(s) through higher layer signaling, and signal whether to perform rate matching (or puncturing) of the RB or RE level on a specific frequency resource (e.g., UL control subband(s)) within the specific symbol(s) through a 1-bit indicator in the UL grant.

In yet another example, in order to reduce overhead of signaling through the UL grant, the gNB may signal a 1-bit indicator in the UL grant, and the information indicated by the indicator may be interpreted differently depending on the situation. As a specific example, when a PUCCH is allocated in a PUSCH transmission slot, the corresponding 1-bit indicator may be interpreted as signaling of whether to perform rate matching (or puncturing) on the specific symbol(s) or whether to perform rate matching (or puncturing) of the RB or RE level on a specific frequency resource (e.g., UL control subband(s)) within the specific symbol(s). On the other hand, when the PUCCH is not allocated in the PUSCH transmission slot, the corresponding 1-bit indicator may be interpreted as signaling of whether rate matching (or puncturing) is to be performed on the specific symbol(s) or whether rate matching (or puncturing) is not to be performed on the specific symbol(s). In this case, in order to minimize the influence of misalignment between the gNB and the UE in PUCCH allocation, a code point indicating “whether to perform rate matching (or puncturing) on the specific symbol(s)” may be identically configured regardless of whether or not the PUCCH is allocated in the PUSCH transmission slot.

Specifically, the code point may indicate a state (e.g., 0 or 1) of the 1-bit indicator. When a PUCCH is or is not allocated in the PUSCH transmission slot, the 1-bit indicator indicating the value of 1 may be interpreted as indicating that rate matching (or puncturing) is performed on the last symbol regardless of the PUCCH. When the 1-bit indicator indicates the value of 1 as in this case, the same UE operation is expected regardless of whether the PUCCH is allocated or not. Accordingly, even when the UE misses the DCI about the PUCCH allocation, the UE may operate without any problem.

3.6. Technical Features that May be Added

More generally, the following two types of subbands may be separately configured according to the uses of the UL control subbands.

(1) First type subband: A resource region that should be protected at all times in PUSCH transmission. When a PUSCH is scheduled in the resource region, the UE should perform rate matching (or puncturing). That is, the UE may determine that the first type subband is a UL control subband configured for another UE, and perform rate matching on the first type subband.

(2) Second type subband: A subband in which a UE may perform PUCCH transmission, and PUCCH resource indexing may be performed or a PUCCH may be allocated. In this case, one PUCCH resource may be confined to be allocated within one specific subband. That is, the UE may determine the second type subband is a UL control subband configured for the UE.

Each of these two types of subbands may be a set of resources which are contiguous or non-contiguous on the time or frequency axis.

A plurality of subbands of each type may be allocated to a specific UE. As an example, when N first type subbands and K second type subbands are allocated to a specific UE, different behaviors of the specific UE may be defined according to the subband to which a specific time/frequency resource belongs. The behaviors of the UE may be broadly divided into the following three cases. Specific behaviors of the UE in each case may be defined as follows.

1) First Case (when a Specific Resource is a Time/Frequency Resource Belonging to Both a First Type Subband and a Second Type Subband)

When the UE transmits the PUSCH on a specific resource, the UE may perform rate matching or puncturing on the corresponding time/frequency resource (or the entire region of the first type subbands including the time/frequency resource). In addition, PUCCH resource indexing may be performed (or a PUCCH may be allocated) only for the corresponding time/frequency resource (or the entire region of the second type subbands including the corresponding time/frequency resource).

2) Second Case (when a Specific Resource is a Time/Frequency Resource that Belongs to a First Type Subband but does not Belong to a Second Type Subband)

When the UE transmits the PUSCH on a specific resource, the UE may perform rate matching or puncturing on the corresponding time/frequency resource (or the entire region of the first type subbands including the corresponding time/frequency resource). In addition, PUCCH resource indexing may not be performed (or the PUCCH may not be allocated) on the corresponding time/frequency resource (or the entire region of the first type subbands including the corresponding time/frequency resource).

3) Third Case (when a Specific Resource is a Time/Frequency Resource that does not Belong to a First Type Subband but Belongs to a Second Type Subband)

When the UE transmits the PUSCH on a specific resource, the UE may perform rate matching or puncturing on a resource on which the PUCCH is actually transmitted among the corresponding time/frequency resources. If the UE does not transmit the PUCCH within the time/frequency resource, the UE may not perform rate matching or puncturing on the resource. In addition, PUCCH resource indexing may be performed (or a PUCCH may be allocated) only on the corresponding time/frequency resource (or the entire region of the second type subbands including the corresponding time/frequency resource).

Alternatively, constraints may be configured on configuration of first type subbands and second type subbands such that the resource considered in the third case among the three cases described above is not present. In one example, the first type subband and the second type subband may always be the same, or only a configuration in which the first type subband includes the second type subband may be allowed.

The configuration of the first type subbands and/or the second type subbands may be predefined in the NR specification (according to the frequency band) or established by broadcast information, information acquired in the initial access step (e.g., a Random Access Response (RAR) message), or system information (e.g., a System Information Block (SIB)) before it is UE-specifically established (through, for example, UE-specific signaling such as DCI or RRC signaling) (by L1 signaling or higher layer signaling). That is, the first type subband and/or the second type subband for the UE may be predefined according to the NR specification, or may be configured according to the broadcast information, the information acquired in the initial access step, or the system information. Then, the configuration of the first type subband and/or the second type subband for the UE may be changed/modified according to the UE-specific configuration.

Here, the first type subband and the second type subband may be configured to be the same. Alternatively, the first type subband and/or the second type subband may be configured to be identical to a carrier bandwidth of the UE configured on a specific carrier.

Before the first type subband and/or the second type subband are UE-specifically configured (by L1 signaling or higher layer signaling), the size of the subbands configured for the UE may be set to a system bandwidth of the corresponding frequency band from the network perspective, or a bandwidth over which a synchronization signal is transmitted, or a bandwidth over which the initial access is performed, the minimum system bandwidth allowed in the frequency band, or the maximum system bandwidth from the perspective of the UE, or a specific value (e.g., the minimum value of the (eMBB) UE bandwidth related capability) less than the maximum system bandwidth from the perspective of the UE. Alternatively, regarding the sizes of the subbands configured for the UE, the first type subband and the second type subband may be configured according to different rules.

Before the first type subband and/or the second type subband are UE-specifically configured (by L1 signaling or higher layer signaling), the positions of the subbands configured for the UE may be a band in which the synchronization signal is transmitted, a band in which the initial access is performed, a band arbitrarily configured in the entire system bandwidth, or a band configured by a specific index (such as a cell index/C-RNTI)-based function (e.g., a hashing function). In terms of the positions of the subbands configured for the UE, the first type subband and the second type subband may be configured according to different rules.

The UE behaviors for each case according to configuration of subbands of the respective types, the method for configuring PUCCH transmission subbands before UE-specific configuration of a UL control subband, and the size or position-related configuration of the PUCCH transmission subbands before the UE-specific configuration of a UL control subband as described above may be equally applied to NR-PUCCHs having various durations. Particularly, when an NR-PUCCH is transmitted through 4 or more symbols, the second type subband described above may be interpreted as the maximum hopping bandwidth of a long NR-PUCCH. In addition, the UE behaviors for each case according to configuration of subbands of the respective types, the method for configuring a channel transmission subband before UE-specific configuration of subbands, and the size or position-related configuration of channel transmission subbands before UE-specific configuration of subbands as described above may be equally applied to the PDCCH and the PDSCH. That is, in the various configurations described above, the ‘UL control subband’ may be replaced with a ‘PDCCH control subband’, and the ‘PDCCH control subband’ may be configured for PDSCH rate matching.

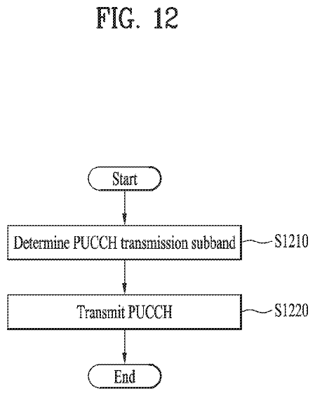

FIG. 12 is a flowchart illustrating a PUCCH transmission method for a UE according to an embodiment of the present invention.

First, the UE determines a PUCCH transmission subband in which a PUCCH is to be transmitted (S1210). Here, the PUCCH transmission subband may be configured differently based on whether a UL control subband is configured.

In an example, in case where a UE receives signaling for configuring an uplink control subband from a base station, the PUCCH transmission subband may be determined as a subband indicated by the received signaling. In this case, the PUCCH transmission subband may be configured independently from a subband for uplink data transmission.

Especially, a bandwidth of the PUCCH transmission subband may be configured to be smaller than a bandwidth of the subband for the uplink data transmission.

In another example, in case where the UE does not receive signaling for configuring an uplink control subband from the base station, the PUCCH transmission subband may be configured to be identical to the subband for uplink data transmission.

Then, the UE transmits a PUCCH using a PUCCH resource in the PUCCH transmission subband determined in S1210 (S1220).

Here, the PUCCH resource, included in the PUCCH transmission subband, on which the PUCCH is transmitted may be determined based on the index of a resource, included in a specific downlink control subband, on which a physical downlink control channel (PDCCH) corresponding to the PUCCH is transmitted. As an example, when the PDCCH corresponding to the PUCCH is transmitted on PDCCH resource index #k, the PUCCH may be transmitted through PUCCH resource index #k in the PUCCH transmission subband.

In addition, the subband in which the PUCCH is transmitted may have a smaller bandwidth than one component carrier supported by the wireless communication system. Here, the one element carrier that may be supported by the NR system to which the present invention is applicable may have a bandwidth of up to 400 MHz.

In addition, when the UE additionally transmits a physical uplink shared channel (PUSCH), the UE may transmit the PUSCH by performing rate matching or puncturing on the PUCCH resource on which the PUCCH is transmitted.

Since examples of the above-described proposal method may also be included in one of implementation methods of the present invention, it is obvious that the examples are regarded as a sort of proposed methods. Although the above-proposed methods may be independently implemented, the proposed methods may be implemented in a combined (aggregated) form of a part of the proposed methods. A rule may be defined such that the base station informs the UE of information as to whether the proposed methods are applied (or information about rules of the proposed methods) through a predefined signal (e.g., a physical layer signal or a higher-layer signal).

### 4. Device Configuration

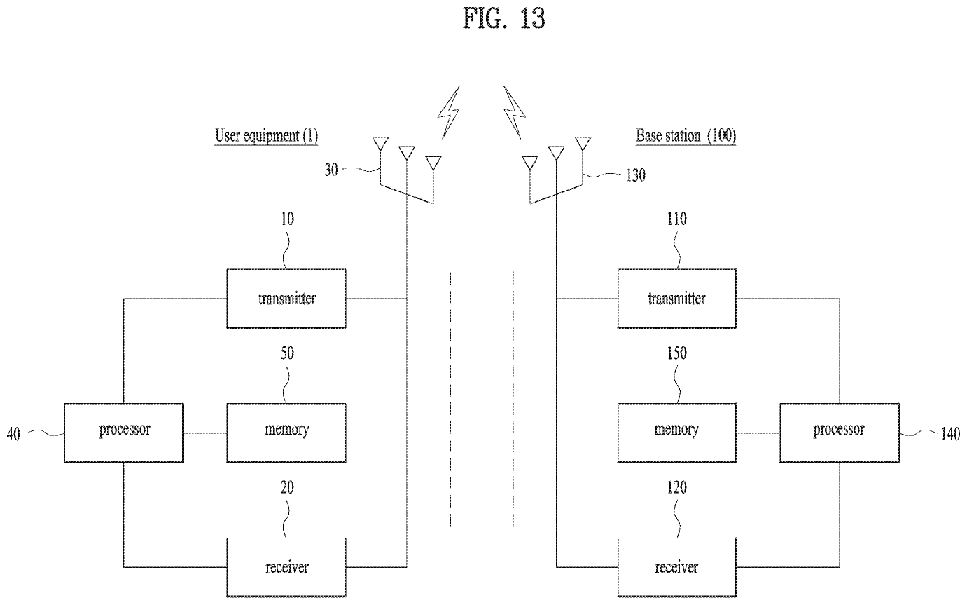

FIG. 13 is a diagram illustrating construction of a UE and a base station in which proposed embodiments can be implemented. The UE and the base station shown in FIG. 13 operate to implement the embodiments of the above-described method for transmitting and receiving a physical uplink control channel between the UE and the base station.

A UE 1 may act as a transmission end on a UL and as a reception end on a DL. A base station (eNB or gNB) 100 may act as a reception end on a UL and as a transmission end on a DL.

That is, each of the UE and the base station may include a Transmitter (Tx) 10 or 110 and a Receiver (Rx) 20 or 120, for controlling transmission and reception of information, data, and/or messages, and an antenna 30 or 130 for transmitting and receiving information, data, and/or messages.

Each of the UE and the base station may further include a processor 40 or 140 for implementing the afore-described embodiments of the present disclosure and a memory 50 or 150 for temporarily or permanently storing operations of the processor 40 or 140.

The UE 1 configured as described above determines, through the processor 40, a PUCCH transmission subband for transmitting a PUCCH based on whether an UL control subband is configured and transmits, through the transmitter 10, the PUCCH using a PUCCH resource in the determined PUCCH transmission subband.

In response, the base station 100 receives, through the receiver 120, the PUCCH using the PUCCH resource in the PUCCH transmission subband determined based on whether an uplink control subband is configured by the base station.

The Tx and Rx of the UE and the base station may perform a packet modulation/demodulation function for data transmission, a high-speed packet channel coding function, OFDM packet scheduling, TDD packet scheduling, and/or channelization. Each of the UE and the base station of FIG. 13 may further include a low-power Radio Frequency (RF)/Intermediate Frequency (IF) module.

Meanwhile, the UE may be any of a Personal Digital Assistant (PDA), a cellular phone, a Personal Communication Service (PCS) phone, a Global System for Mobile (GSM) phone, a Wideband Code Division Multiple Access (WCDMA) phone, a Mobile Broadband System (MBS) phone, a hand-held PC, a laptop PC, a smart phone, a Multi Mode-Multi Band (MM-MB) terminal, etc.

The smart phone is a terminal taking the advantages of both a mobile phone and a PDA. It incorporates the functions of a PDA, that is, scheduling and data communications such as fax transmission and reception and Internet connection into a mobile phone. The MB-MM terminal refers to a terminal which has a multi-modem chip built therein and which can operate in any of a mobile Internet system and other mobile communication systems (e.g. CDMA 2000, WCDMA, etc.).

Embodiments of the present disclosure may be achieved by various means, for example, hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present disclosure may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

The present disclosure is applicable to various wireless access systems including a 3GPP system, and/or a 3GPP2 system. Besides these wireless access systems, the embodiments of the present disclosure are applicable to all technical fields in which the wireless access systems find their applications. Moreover, the proposed method can also be applied to mmWave communication using an ultra-high frequency band.

1. A method of transmitting a physical uplink control channel (PUCCH) by a user equipment (UE) to a base station in a wireless communication system, the method comprising:
determining a PUCCH transmission subband for transmitting a PUCCH based on whether a uplink (UL) control subband is configured; and
transmitting the PUCCH using a PUCCH resource in the determined PUCCH transmission subband.

2. The method of claim 1, wherein when signaling for configuring the UL control subband is received from the base station, the PUCCH transmission subband is determined as a subband indicated by the received signaling,
wherein the PUCCH transmission subband is configured independently from a subband for uplink data transmission.

3. The method of claim 2, wherein a bandwidth of the PUCCH transmission subband is configured to be smaller than a bandwidth of the subband for the uplink data transmission.

4. The method of claim 1, wherein when signaling for configuring a UL control subband is not received from the base station, the PUCCH transmission subband is configured to be identical to a subband for uplink data transmission.

5. The method according to claim 1, wherein the PUCCH resource, included in the PUCCH transmission subband, on which the PUCCH is transmitted is determined based on an index of a resource, included in a specific downlink control subband, on which a physical downlink control channel (PDCCH) corresponding to the PUCCH is transmitted.

6. The method of claim 1, wherein the subband in which the PUCCH is transmitted has a smaller bandwidth than one component carrier supported by the wireless communication system.

7. The method of claim 6, wherein the one component carrier has a bandwidth of up to 400 MHz.

8. The method of to claim 1, wherein when the UE transmits a physical uplink shared channel (PUSCH), the UE transmits the PUSCH by performing rate-matching or puncturing on the PUCCH resource on which the PUCCH is transmitted.

9. A method of receiving a physical uplink control channel (PUCCH) by a base station from a user equipment (UE) in a wireless communication system, the method comprising:
receiving the PUCCH using a PUCCH resource in a PUCCH transmission subband determined based on whether a UL control subband is configured by the base station.

10. A user equipment for transmitting a physical uplink control channel to a base station in a wireless communication system, the user equipment comprising:
a transmitter; and
a processor operatively coupled with the transmitter,
wherein the processor is configured to:
determine a PUCCH transmission subband for transmitting a PUCCH based on whether a uplink (UL) control subband is configured; and
transmit the PUCCH using a PUCCH resource in the determined PUCCH transmission subband.

11. A base station for receiving a physical uplink control channel from a user equipment terminal in a wireless communication system, the base station comprising:
a receiver; and
a processor operatively coupled with the receiver,
wherein the processor is configured to receive the PUCCH using a PUCCH resource in a PUCCH transmission subband determined based on whether a UL control subband is configured by the base station.
